(19) United States
(12) Patent Application Publication
(10) Pub. No.: US 2009/0009001 A1
(43) Pub. Date: Jan. 8, 2009

(54) METHOD AND APPARATUS FOR SYNCHRONIZATION OF ACTIONS IN A PARALLEL UPS SYSTEM USING A SERIAL COMMUNICATIONS BUS

(75) Inventors: Mohammad Nanda Rahmana MARWALI, Lewis Center, OH (US); Kevin Kim ESCHHOFEN, Lewis Center, OH (US); John Franz CHRISTENSEN, Lewis Center, OH (US); Brian Paul HEBER, Delaware, OH (US)

Correspondence Address: LOCKE LORD BISSELL & LIDDELL LLP;ATTN: IP DOCKETING, 600 TRAVIS STREET, 3400 CHASE TOWER, HOUSTON, TX, 77002, US

(73) Assignee: LIEBERT CORPORATION, Columbus, OH (US)

(21) Appl. No.: 11/773,755

(22) Filed: Jul. 5, 2007

(51) Int. Cl. H02J 9/00

(52) U.S. Cl. 307/65

(57) ABSTRACT

A serial communications bus is utilized to send key action data between parallel UPS units. The communications bus is used to transmit data at the zero crossing of the critical bus voltage. Each UPS unit then takes action based upon the event data received at the next zero crossing of the critical bus voltage.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The present invention relates generally to uninterruptible power supply (UPS) systems, and more particularly to two or more UPS systems connected and operated in parallel wherein synchronization of actions between the UPS systems takes place using a serial communications bus.

2. Description of the Related Art

A UPS system is used in applications that require continuity of power, such that when the main power source fails, the UPS system provides power from a reserve energy stored system, typically in the form of a battery. The UPS system monitors the main power source and controls the UPS components to provide continuous power to a critical load.

To provide further continuity of power, multiple UPS units may be paralleled with other UPS units to form a redundant and scalable UPS system with a given multiplicity. This system adds redundancy in that any UPS unit may be disconnected from the critical load for service or automatically by the UPS unit to isolate a faulty unit. The remaining unit(s) still provide power to the critical load. In addition, this system allows flexibility in increasing the total power capacity of the system. Typically, when UPS units are paralleled, some unit-to-unit wiring is added to facilitate the sharing of power and the connection or disconnection of units.

Coordinated action taken by units in a UPS system with paralleled UPS units is vital to ensuring continuous, quality power is provided to the critical load. Coordinating action is typically done with discrete signals wired between each UPS unit. This approach is costly, creates complicated wiring schemes and has no flexibility. The use of discrete digital signaling requires that each command or action between UPS units require a separate wired-OR-bus, which requires a dedicated wire for each command or action.

In a parallel UPS system, there are many actions that are not required to be executed with a minimum time delay, but these actions are still required to be performed by all UPS units at virtually the same instant of time in order not to disrupt the proper operation of the paralleled system

An example of such an action is a manual/automatic retransfer to the UPS unit. This action includes requests to transfer power from the alternate AC source to the inverters of the UPS unit by closing the circuit breakers and turning off the static bypass switch (SBS). These requests originate from a user pressing a button on the human-machine interface (HMI) of the system, or may result from an automatic request from the internal controller of the UPS unit to transfer the load back to the UPS unit at some period of time after an emergency transfer to bypass was executed. These actions can tolerate some delay as to when they are accomplished, but all UPS units must perform the actions at the same instant of time in order to prevent improper load current sharing between inverters and the bypass source.

An additional action is a manual transfer to an SBS. This is a request from a user to transfer the power from the inverters to the bypass source by opening the output circuit breakers and turning on the SBS.

A further action that is required to be performed by all UPS units at virtually the same instant in time is an overload transfer to an SBS. This action is a request determined by the controllers of the UPS units that an overload condition is detected at the load when powered by the inverters. For a relatively small overload, the UPS system may allow the conditions to last for relatively long periods of time before a transfer to an SBS is required. In this instance, some delay in performing the action can be tolerated, but still the actions are required to be performed synchronously.

A further action to be performed by all UPS units is a set point change. There are instances when the user desires to change the set points related to the inverter's output voltage generation, such as voltage amplitude and frequency. Again, some delay can be tolerated, but each UPS unit must implement the changes at the same time in order not to disrupt proper load current sharing between units.

A need has thus arisen for a method and apparatus for synchronization of actions in a parallel UPS system where such communications can be implemented in a relatively fast, error free condition and can be received and acted upon by each UPS unit at the same time.

### BRIEF SUMMARY OF THE INVENTION

In accordance with the present invention, a serial communications bus is utilized to send key action data between parallel UPS units. The communications bus is used to transmit data at the zero crossing of the critical bus voltage. Each UPS unit then takes action based upon the event data received at the next zero crossing of the critical bus voltage.

### BRIEF DESCRIPTION OF THE SEVERAL VIEWS OF THE DRAWINGS

For a more complete understanding of the present invention and for further advantages thereof, reference is now made to the following Description of the Preferred Embodiments taken in conjunction with the accompanying Drawings in which:

FIG. 1 illustrates a block diagram illustrating the present UPS system;

FIGS. 2a, 2b and 2c illustrate wave forms illustrating operation of the present method;

FIG. 3 illustrates a block diagram of an implementation of a controller for use with the present UPS system;

FIG. 4 illustrates a computer flow chart illustrating a periodic timer interrupt service routine; and

FIG. 5 illustrates a computer flow chart illustrating a zero cross interrupt service routine.

### DETAILED DESCRIPTION

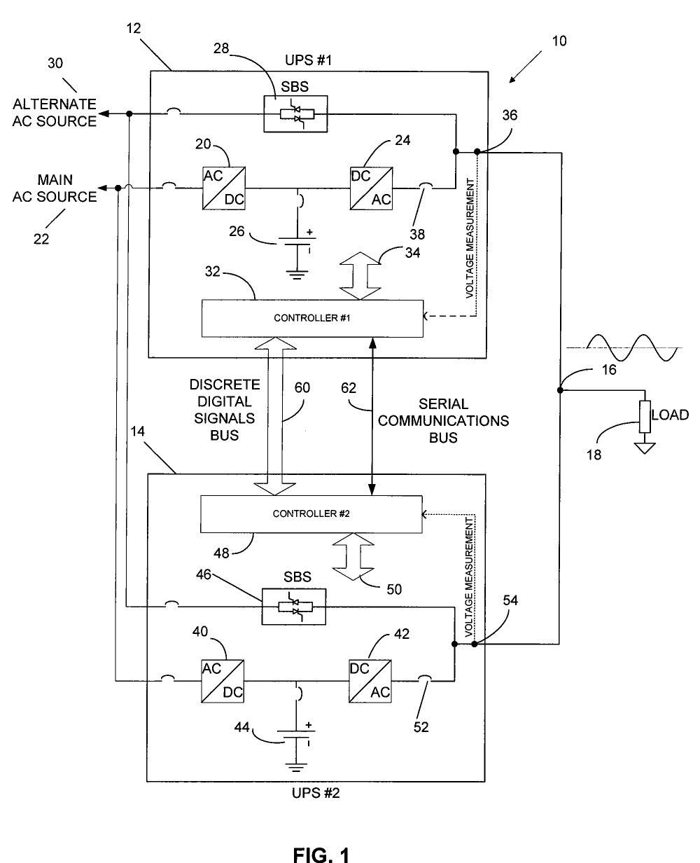

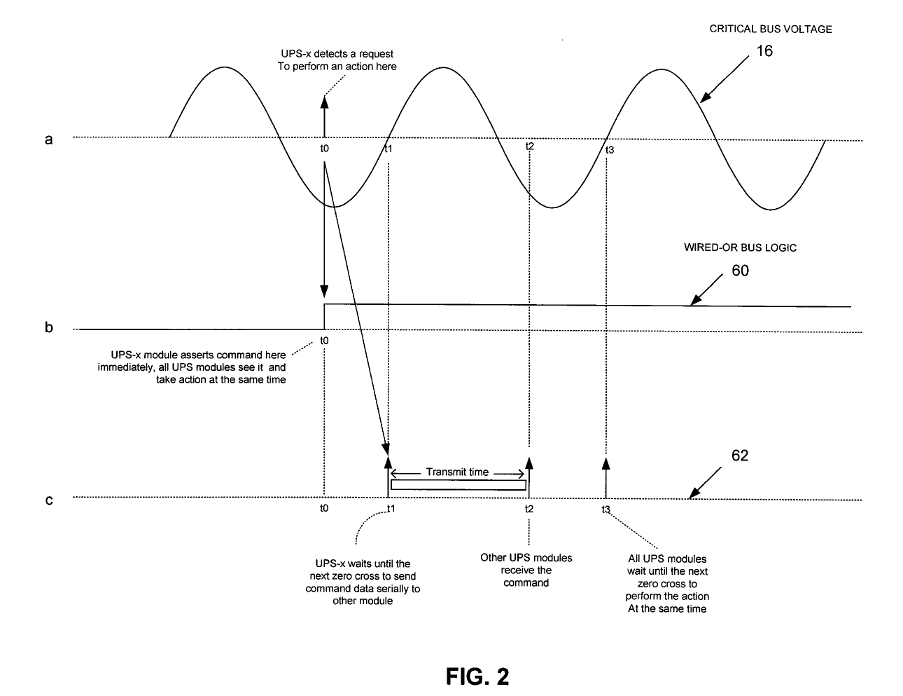

Referring to FIG. 1, the present UPS system, generally defined by the numeral 10 is illustrated. UPS system 10 includes a UPS unit 12 and a UPS unit 14 connected in parallel to create UPS system 10. Although two UPS units 12 and 14 are illustrated in FIG. 1, it should be understood that any number of UPS units may be connected in parallel, and units 12 and 14 are shown for illustrative purposes only. The output of units 12 and 14 generate a critical bus voltage 16 (FIG. 2a) which is applied to a critical load 18.

UPS unit 12 includes a rectifier 20 that converts input power from an AC power source 22 to DC power. AC power source 22 may be provided from utility power or another AC power source such as a generator. Rectifier 20 is connected to a first power source, also referred to as an inverter 24 which converts the DC power to a regulated conditioned AC power. A battery 26 provides reserved DC energy in the event that there is a utility power outage.

UPS unit 12 further includes a static bypass switch (SBS) 28 which connects an alternate AC source 30 to load 18 in the event that first power source 24 fails. Alternative AC source 30 may optionally be connected to the same source as AC source 22 or it may be supplied from a separate AC source. Devices suitable for static bypass switch 28 include SCRs, triac and IGBT, for example. UPS unit 12 further includes a controller 32 which controls the operation of unit 12 including operation of rectifier 20, activation/deactivation of SBS 28, and controlling operation of inverter 24. Control of these components is through control and feedback signal measurements provided on bus 34. The output voltage 36 of inverter 24 is normally part of the feedback signal measurement of bus 34, but is shown separately in FIG. 1 being applied to controller 32 to describe the present method.

A circuit breaker 38 is also provided within UPS unit 12. A request to transfer power from source 30 to inverter 24 is accomplished by closing circuit breaker 38 and turning off SBS 28.

Under normal conditions, inverter 24 supplies power to critical load 18. In the event that inverter 24 fails, controller 32 turns off inverter 24 and turns on SBS 28 thereby transferring critical load 18 from inverter 24 to the alternative source 30 thereby maintaining power to critical load 18.

To provide further redundancy and scalability, UPS units, such as UPS unit 12 may be paralleled with additional UPS units such as second UPS unit 14. UPS unit 14 has the same subsystems as UPS unit 12 including a rectifier 40, inverter 42, battery 44, SBS 46, controller 48, bus 50 and circuit breaker 52. The output voltage 54 of inverter 42 is applied to controller 48.

As previously stated, a plurality of UPS units 12 and 14 may be connected in parallel and controllers 32 and 48 in each unit is configured to operate in tandem with the other controller(s).

Communications between UPS units 12 and 14 are accomplished utilizing a discrete digital signals communications bus 60 and, in accordance with the present invention, a serial communications bus 62.

Bus 60 provides discrete digital communications by utilizing, for example, a wired-OR-bus logic in which each UPS unit 12 and unit 14 may influence a common bus logic level which is monitored by each UPS unit to indicate a request for all UPS units to take certain action all at the same time.

Referring to FIG. 2, FIG. 2a illustrates the critical bus voltage 16 applied to critical load 18. As shown in FIG. 2b, signaling on bus 60 occurs when a UPS unit detects a request to perform an action at time to and immediately asserts the bus logic, and other UPS units take action at practically the same time. Signaling on bus 60 is used for those actions that need to be implemented by all UPS units with minimum time delay. Such an action is in the event that critical bus voltage 16 fails when inverters 24 or 42 are powering load 18, UPS system 10 must transfer load 18 automatically to the alternate source 30 by turning on SBS 28 or 46 and opening circuit breakers 38 or 52. This action must be performed by all UPS units 12 and 14 at the same time and with minimum time delay in order to maintain continuity of power to load 18.

However, as previously stated, a problem associated with discrete digital signaling is that each command/action will require a separate wired-OR-bus, which requires a dedicated wire for each command/action to be communicated between units 12 and 14.

The present invention utilized serial communications bus 62 to transmit key event data between UPS units 12 and 14. Bus 62 may comprise, for example, a controller area network (CAN), RS485 and other serial communications. The present invention utilizes the output voltages 36 and 54 of units 12 and 14. As shown in FIG. 2c, when a UPS unit 12 or 14 detects a request to perform an action at time to, the UPS unit waits until time t₁ which is the next occurrence of a zero crossing of the voltage of the critical bus voltage 16 to broadcast the request to other UPS units through the serial communications bus 62. Since the command data is transmitted serially, there will be a finite time delay before the receiving UPS units receive the command. Once the serial data is fully received by all units at time t₂, the receiving units wait until another voltage zero cross at time t₃ before performing the action.

The use of bus 62 enables more than a single command to be decoded into one serial communication data stream, so only one serial bus wiring is necessary to accomplish many commands. The present invention thereby eliminates numerous wires between UPS units in a parallel system. The communication performed by bus 62 is not required to take place at an extremely high speed. So long as the transmit time, t₂−t₁, is less than one line cycle period of the voltage, the distance between two positive zero crosses, then synchronization of UPS units 12 and 14 can be achieved. On average, there may be between, for example, 20 and 30 signals that are required to be communicated between UPS units 12 and 14. Utilizing the present invention, the number of wired signals can be reduced to, for example, 3 or 4 utilizing bus 60, which results in a cost savings and reduces the complexity of the communications required between parallel units 12 and 14. Those events that require immediate action are wired directly between units 12 and 14 utilizing bus 60 whereas those communications which can be slightly delayed, but which still must be synchronized, utilize bus 62 of the present invention.

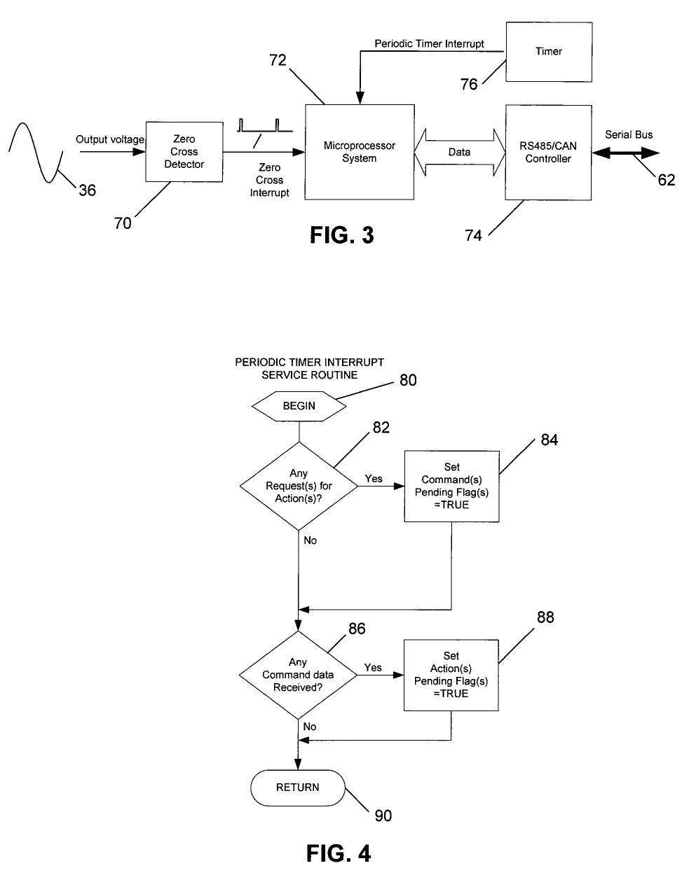

Referring now to FIG. 3, an example of a controller 32 or 48 within units 12 and 14 is illustrated. The output voltage 36 (or 54) is applied to a zero cross detector 70 to generate a logic pulse at a zero cross of the output voltage. This logic pulse is used to generate an interrupt to a microprocessor system 72. Microprocessor system 72 includes a serial communication controller 74 for transmitting and receiving data on serial bus 62. A timer 76 generates a periodic timer interrupt every regular interval of time to microprocessor system 72. This interrupt is preferably less than the one line cycle of voltage 36. For example, for a 60 Hz voltage system with one line cycle period of 1/60 s=16.6667 ms, a periodic interrupt of the order of, for example, 0.1-0.5 ms is a desired choice.

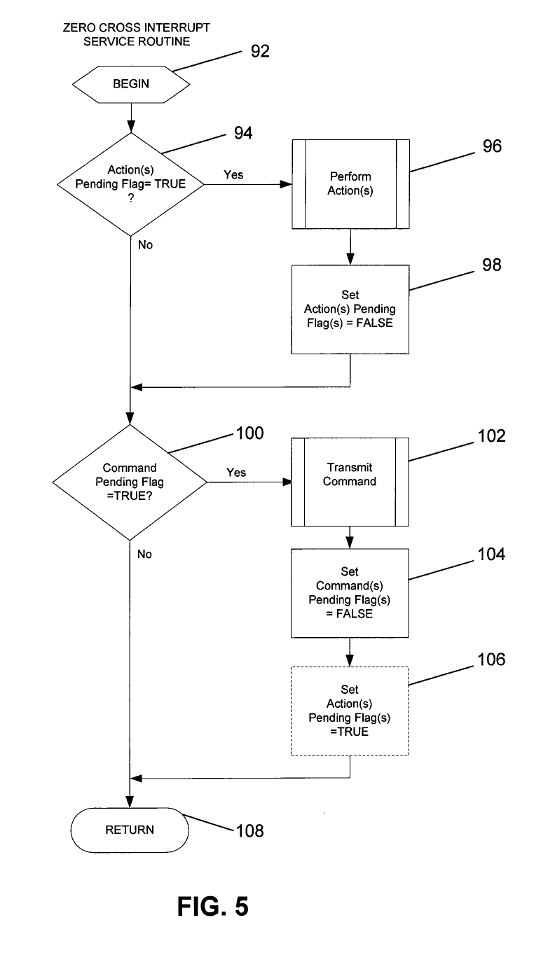

FIGS. 4 and 5 illustrate the flow chart of the software which may be utilized to implement the controller functions shown in FIG. 3. Referring to FIG. 4, the periodic timer interrupt service routine begins at step 80. At every periodic timer interrupt, each UPS unit checks to see if there is any request for an action at step 82. If there is a request for action, the system will set a software flag, True, at step 84 which indicates that the command is pending to be broadcast to other units. The actual command broadcast will be performed at the next occurrence of a voltage zero cross. If no requests for action are pending or if the command flag has been set True, the next step is to determine whether a new command has been received from a controller 32 or 48 at step 86. If a command has been received, a flag, True, indicating that action is pending is set at step 88. This action will be performed at the next occurrence of voltage zero cross. If no command has been received or if the flag has been set True at step 88, the flow returns at step 90.

Referring to FIG. 5, the software to implement a zero cross interrupt service routine is shown. The routine begins at step 92 when a zero cross interrupt occurs, the controller 32 or 48 checks at step 94 to determine if an action pending is to be performed. If a flag had previously been set at step 88, the pending flag is True and the action is performed at step 96. The pending flag will then be cleared at step 98 and set False to prevent multiple actions being performed for a single command. At step 100, a determination is made if a command flag is set at True having previously been set at step 84, if the flag is True, the command is transmitted at step 102 over bus 62, and the flag is reset to False at step 104. The set actions pending flag may be set True at step 106, and the flow returns at step 108.

The Figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

What is claimed is:

1. A method for synchronization of actions in a parallel uninterruptible power supply (UPS) system comprising:
providing a plurality of UPS units connected in parallel, each UPS unit including a controller and the paralleled units generating an alternating current output voltage;
connecting the controllers of the UPS units with a serial communications bus;
detecting on the serial bus a request to perform an action;
delaying in time until the output voltage has alternated to zero; and then
communicating the request to the at least one other UPS unit via the serial communications bus.

2. The method of claim 1, further comprising performing the action after the voltage has alternated to zero.

3. The method of claim 1, wherein the serial bus is a controller area network.

4. The method of claim 1, wherein the serial bus is an RS485 bus.

5. The method of claim 1, wherein the time required communicating the request is less than one full cycle of the output voltage.

6. The method of claim 2, wherein performing the action occurs on the second zero crossing after detecting the request.

7. The method of claim 2, wherein the performing the action occurs on the third zero crossing after detecting the request.

8. A method for controlling a parallel uninterruptible power supply (UPS) system comprising:
providing at least first and second UPS units connected in parallel, each UPS unit including a controller and the units generating an alternating current output voltage;
connecting the controllers of the at least first and second UPS units with a serial communications bus;
detecting on the serial bus a request to perform an action;
delaying in time until the output voltage has alternated to zero;
communicating the request to the at least one other UPS unit via the serial communications bus;
delaying in time until the output voltage has alternated to zero; and
performing the action substantially simultaneously by the at least two UPS units.

9. The method of claim 8, wherein the serial bus is a controller area network.

10. The method of claim 8, wherein the serial bus is an RS485 bus.

11. The method of claim 8, wherein the time required communicating the request is less than one full cycle of the output voltage.

12. The method of claim 8, wherein performing the action occurs on the second zero crossing after detecting the request.

13. The method of claim 8, wherein performing the action occurs on the third zero crossing after detecting the request.

14. An uninterruptible power supply (UPS) system having an alternating current output voltage, comprising:
a plurality of UPS units, each unit including a controller; and
a serial communications bus interconnecting the controllers for synchronizing operation of the units based upon a zero volt event in the output voltage.

15. The UPS system of claim 14, wherein each of the controllers comprises:
a zero volt detector for generating a signal at a zero volt crossing of the output voltage; and
a processor responsive to receipt of a signal to transmit data on the serial communications bus.

16. The UPS system of claim 15, wherein at least one of the controllers is programmed to:
detect on the serial bus a request to perform an action;
delay until the output voltage has alternated to zero; and
communicate the request to the other UPS units via the serial communications bus.

17. The UPS system of claim 16, wherein the controllers receiving the request are each programmed to
delay in time until the output voltage has alternated to zero; and
perform the action substantially simultaneously with the other UPS units.

18. The UPS system of claim 17, wherein the amount of time required communicating the request to the other UPS units is less than one full output voltage cycle.

19. The UPS system of claim 14 further comprising:
a discrete digital communication bus interconnecting the controllers.

20. The UPS system of claim 16 wherein the discrete digital communication bus is a wired logic bus.
